(19) United States
(12) Patent Application Publication
(10) Pub. No.: US 2025/0352925 A1
(43) Pub. Date: Nov. 20, 2025

(54) CONTINUOUS FIXED BED CHROMATOGRAPHY, ADSORPTION, AND ION EXCHANGE SYSTEM

(71) Applicant: Amalgamated Research LLC, Twin Falls, ID (US)

(72) Inventors: Peter Thomas Ferrero, V, Twin Falls, ID (US); Lily Crane, Twin Falls, ID (US); Alexander H.W. Risner, Twin Falls, ID (US); Olivia Madalein Gluth, Twin Falls, ID (US); Cade Grant Haskell, Twin Falls, ID (US)

(21) Appl. No.: 18/668,846

(22) Filed: May 20, 2024

(51) Int. Cl. B01D 15/18; B01D 15/26; B01D 15/36

(52) U.S. Cl. CPC B01D 15/1885; B01D 15/1871; B01D 15/265; B01D 15/361

(57) ABSTRACT

A continuous fixed bed separation system includes a plurality of fixed bed treatment columns, a valve system, and a controller. The valve system provides a continuous flow loop through the plurality of fixed bed treatment columns. The flow loop passes through at least one subset of columns of the plurality of fixed bed treatment columns in parallel. A controller changes the valve system to modify the position of an inlet and an outlet within the flow loop and modify each subset of columns in parallel to include a new subset of columns of the plurality of fixed bed treatment columns in parallel. The new subset of columns partially overlaps with the previous subset of columns. The positions of the valve system are cycled such that each fixed bed treatment column ultimately performs each step of a multi-step separation treatment within the system.

### TECHNICAL FIELD

This disclosure relates generally to chromatography, adsorption, and ion exchange systems. More particularly, this disclosure relates to maximizing the productivity of resins and adsorbents through the use of selective parallelization of treatment columns.

### BACKGROUND

Continuous chromatographic, adsorption, and ion exchange systems are used extensively in the sugar, food and beverage, precision fermentation, pharmaceutical, bioprocessing, fine chemicals, water treatment, and hydrometallurgy industries amongst many others. The use of chromatography, adsorption, and ion exchange systems is particularly well-suited for applications requiring purification of highly similar chemical analogues, recovery of trace components, or separation of thermally unstable components which are uneconomical for other traditional technologies such as distillation, solvent extraction, and membrane filtration. The design of chromatographic, adsorption, and ion exchange systems is subject to both performance and economic constraints, the former involving requirements on product purity and recovery and the latter including energy usage, required resin volumes, and eluent consumption rates which are to be optimized.

It is common that the performance constraints are restrictive to such a degree as to render at least one of the economic constraints to be non-optimal. Due to concerns regarding operating costs of the system, usually productivity is the first constraint to be relaxed which results in larger resin volume requirements in addition to larger sized equipment for an industrial system as opposed to increasing energy usage and eluent consumption rates.

### SUMMARY

In at least one example, a continuous fixed bed separation system includes a plurality of fixed bed treatment columns, a valve system, and a controller. Each column of the plurality of fixed bed treatment columns includes a resin or adsorbent. The valve system provides a continuous flow loop through the plurality of fixed bed treatment columns. The flow loop includes an inlet and an outlet. The flow loop passes through at least one subset of columns of the plurality of fixed bed treatment columns in parallel. The controller is configured to cyclically change the valve system to modify the position of the inlet and the outlet within the flow loop and modify each subset of columns in parallel to include a new subset of columns of the plurality of fixed bed treatment columns in parallel. The new subset of columns partially overlaps with the previous subset of columns such that at least one column of the new subset of columns was not within the previous subset of columns, at least one column of the previous subset of columns is not within the new subset of columns, and at least one column of the new subset of columns was within the previous subset of columns.

In some examples, the plurality of fixed bed treatment columns is between 3 columns and 20 columns. In some examples, the at least one subset of columns in parallel is at least two subsets of columns in parallel. In some examples, the system is a chromatographic system, an adsorption system, or an ion exchange system

In at least one example, a continuous fixed bed separation system includes a plurality of fixed bed treatment columns and a plurality of blocks of fixed bed treatment columns. Each block includes at least one fixed bed treatment column. Each fixed bed treatment column includes a resin or adsorbent. The plurality of blocks of fixed bed treatment columns are configured to perform a corresponding number of treatment steps in a multi-step separation treatment of mixtures with each block configured to perform a respective treatment step of the multi-step separation treatment. The plurality of blocks are fluidly connected in series, and include at least a first block configured to perform a first treatment step and a second block to perform a second treatment step. A process time for the second treatment step is greater than a process time for the first treatment step. The second block includes a plurality of fixed bed treatment columns in parallel fluid communication within the block.

In some examples, the plurality of blocks includes a third block to perform a third treatment step of the multi-step separation treatment and may also include a fourth block to perform a fourth treatment step of the multi-step separation treatment. The third block and/or the fourth block may include a plurality of fixed bed treatment columns configured in a parallel arrangement.

In some examples, the first treatment step of the multi-step separation treatment may be one of an elution step, a feed displacement step, a regeneration step, a conditioning step, a rinsing step, or an effluent recycle step. In some examples, the second treatment step of the multi-step separation treatment may be a loading step.

In some examples, the continuous fixed bed separation system includes a valve system providing a flow path through the plurality of blocks of fixed bed treatment columns. The valve system is operable to arrange the plurality of fixed bed treatment columns into the plurality of blocks and to connect the blocks in series within a flow loop. The valve system is operable to cycle through a plurality of valve positions with each of the plurality of valve positions having a different arrangement of the plurality of fixed bed treatment columns into the plurality of blocks. Each block has the same number of fixed bed treatment columns in each of the plurality of valve positions.

In at least one example, a method of operating a continuous fixed bed separation system includes fluidly connecting a plurality of fixed bed treatment columns with a first valve configuration. The first valve configuration arranges the plurality of fixed bed treatment columns into a plurality of distinct blocks and fluidly connects the plurality of blocks in series. The first valve configuration arranges a subset of the plurality of fixed bed treatment columns in parallel fluid communication within a first block of the plurality of blocks. The method includes receiving a mixture from a feed inlet into the plurality of fixed bed treatment columns. The feed inlet may be positioned between two adjacent columns of the plurality of fixed bed treatment columns.

In some examples, the plurality of blocks is four blocks and the plurality of fixed bed treatment columns is at least five columns. In some examples, the plurality of blocks is five blocks and the plurality of fixed bed treatment columns is at least six columns. In some examples, the plurality of fixed bed treatment columns is less than 20 columns. In some examples, the plurality of fixed bed treatment columns is 3 or more columns. In some examples, the plurality of fixed bed treatment columns is 10 or less columns. In some examples, the system is a chromatographic system. In some examples, the system is an adsorption system. In some examples, the system is an ion exchange system.

The method includes simultaneously performing a plurality of treatment steps within the plurality of blocks during the first valve configuration. Each treatment step of the plurality of treatment steps is performed within a corresponding block. The method includes removing an effluent from the plurality of fixed bed treatment columns via an effluent outlet. The effluent outlet may be positioned between two adjacent columns of the plurality of fixed bed treatment columns.

The method includes realigning the fluid connections of the plurality of fixed bed treatment columns by shifting the positions of the inlet and the outlet. The positions of the inlet and the outlet may be shifted to the next downstream positions between two adjacent columns of the plurality of fixed bed treatment columns. Realigning the fluid connections of the plurality of fixed bed treatment columns rearranges the plurality of fixed bed treatment columns into the blocks. The first block includes a new subset of columns of the plurality of fixed bed treatment columns in parallel. The new subset of columns partially overlaps with the previous subset of columns such that at least one column of the new subset of columns was not within the previous subset of columns, at least one column of the previous subset of columns is not within the new subset of columns, and at least one column of the new subset of columns was within the previous subset of columns. The method may include cyclically realigning the fluid connections of the plurality of fixed bed treatment to ensure sufficient contact between the solid and liquid phases of the mixture.

It is to be understood that both the foregoing description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE FIGURES

FIG. 1 is an illustration of the potential input and output flow pathways of a treatment step for a block of a multi-step treatment system, according to an embodiment.

FIG. 2 is a schematic view of a first column shift interval of a five column adsorption sequence for a multi-step treatment system, according to an embodiment.

FIG. 3 is a schematic view of a second column shift interval of a five column adsorption sequence for a multi-step treatment system, according to an embodiment.

FIG. 4 is a schematic view of a third column shift interval of a five column adsorption sequence for a multi-step treatment system, according to an embodiment.

FIG. 5 is a schematic view of a fourth column shift interval of a five column adsorption sequence for a multi-step treatment system, according to an embodiment.

FIG. 6 is a schematic view of a fifth column shift interval of a five column adsorption sequence for a multi-step treatment system, according to an embodiment.

FIG. 7 is a schematic view of a sixth column shift interval of a five column adsorption sequence for a multi-step treatment system, according to an embodiment.

FIG. 8A is a schematic view of a multi-step treatment system, according to an embodiment.

FIG. 8B is a schematic view of a multi-step treatment system including multiple blocks each having columns in parallel, according to an embodiment.

FIG. 8C is a schematic view of a multi-step treatment system including a block of columns in parallel, according to an embodiment.

FIG. 9A is a schematic view of a multi-step treatment system where the rate of adsorption constrains the required duration of a loading step of an adsorption cycle, according to an embodiment.

FIG. 9B is a schematic view of one column shift interval of a multi-step treatment system where the loading step includes a block of columns in parallel, according to an embodiment.

FIG. 10 illustrates a method to increase the productivity of a chromatography, adsorption, or ion exchange system, according to an embodiment.

### DETAILED DESCRIPTION

The present disclosure relates to systems and methods for minimizing the volume of resin or adsorbent for a chromatography, adsorption, or ion exchange application via the precise balancing of the fluid process times for rate-limiting steps during the adsorption, ion exchange, and chromatography cycles via cycle step parallelization. It is common to increase the duration of the steps in the chromatography, adsorption, or ion exchange cycle to satisfy the longer duration required to satisfactorily execute the rate-limiting step of the cycle at the expense of system productivity. Typical rate-limiting factors for a chromatography, adsorption, or ion exchange cycle are satisfactory contact for the loading or elution steps or the pressure drop across a resin or adsorbent bed when processing viscous materials at higher flowrates.

Alternatively, other approaches used by those skilled in the art for increasing productivity include utilizing lead-lag style systems, with two columns being loaded in series and a single column being regenerated for further loading, and countercurrent ion exchange (CCIX) systems. These systems maximize the driving force for binding and releasing target compounds from the resin bed via effective countercurrent contact of the process fluid with the selective stationary phase. However, these two methods each have drawbacks that do not result in an optimal solution for maximizing resin or adsorbent productivity. Namely, for lead-lag systems, the productivity of the system is still constrained by the rate-limiting step of the cycle and often leads to the column undergoing regeneration idling while the two columns in series complete the loading step of the cycle.

Conversely, while the CCIX system does achieve high rates of productivity through simulating countercurrent contact of the process fluid with the resin or adsorbent, typically 20 to 30 resin beds are required to achieve these high productivity rates. However, herein a system for achieving maximal resin or adsorbent productivity during a multi-step process utilizes more columns than treatment steps, but is effective with fewer than 20 columns, such as fewer than 10 columns. In some examples, between 3 and 20 columns are utilized. Examples for the disclosed system include sucrose recovery from molasses sources, purification of fructose from high fructose corn syrup or invert sugar, recovery of lithium from various brine sources, recovery of proteins from dairy and fermentation feedstocks, and purification of organic acids from fermentation broths.

For the purposes of clarity within the present disclosure, the following terms are defined as follows:

The term “cycle” means the set of operations for a chromatographic, adsorption, or ion exchange system that purifies a component from a mixture and returns the resin or adsorbent to an initial condition. For example, a representative cycle may include a loading step, a feed displacement step, an elution step, and an eluent recycle step although other operations may also be performed in addition to those listed depending on the requirements of the process.

The term “step” means a single operation within a chromatographic, adsorption, or ion exchange system. A representative example of a step can include the loading step, the feed displacement step, the elution step, and the eluent recycle step amongst others depending on the requirements of the process.

The term “block” means a subset of columns of a system all simultaneously performing the same step of a chromatographic, adsorption, or ion exchange process to achieve the same function. Although each column is performing the same step within the block, different columns within the block may be at different intervals within that step, as will be discussed in more detail below.

The term “set” means a subunit within a block of columns. In reference to the usage of the term, “two sets” would refer to two subunits of columns within a block performing different portions of the same cycle step simultaneously and in parallel. Each set may consist of a single column or multiple columns linked in series to one another.

The term “columns per set” or “columns in series per set” means the number of columns connected in series within a single set of a single block.

The term “sequence” means the cyclical positioning of discrete valves along the fixed bed chromatographic, adsorption, or ion exchange system. An entire sequence consists of the group of column shift intervals (i.e., the time between column shifts) required to ensure that each column performs an entire chromatographic, adsorption, or ion exchange cycle. For example, a sequence has K columns shifts before returning to the starting valve configuration and repeating, where K is the total number of sets of columns comprising a particular embodiment of the disclosure.

The term “column shift” means the physical change in valve configuration that results in each open valve being shifted from fluid communication with one respective set of columns to the next set of columns downstream in the system. For a last column position in an example of the disclosure, the column shift moves the open valve configuration to the position of the first column in the system, in effect creating a loop within the system. In addition, a subset of valves on the outlet side of the columns can be selectively opened and closed during a column shift interval to divert fractions of the process streams to different process vessels or process tanks, which is referred to herein as an outlet switch.

The term “parallelization” or “in parallel” means using multiple sets of columns within a block to perform a portion of the same step within the chromatographic, adsorption, or ion exchange cycle simultaneously over a given period of time.

Maximizing the productivity of a continuous chromatography, adsorption, or ion exchange system through the use of multiple sets of columns operating in parallel within a block can balance the duration of each step of the chromatography, adsorption, or ion exchange cycle. For example, each cycle step can be performed over the optimal time duration by the addition of more parallel sets of columns selectively operating in parallel. In some examples, the majority of productivity gains may be realized with less than 10 columns, which contrasts to a CCIX system using between 20 and 30 columns to achieve similar levels of productivity. The systems described here are configured to perform a multi-step separation treatment of mixtures. In some examples, this multi-step separation treatment may include an elution step, a feed displacement step, a rinsing step, a loading step, and/or an eluent recycle step. Within the multi-step treatment system, the fixed-bed treatment columns are fluidly connected in series, but some fixed-bed treatment columns are fluidly connected in parallel within a block of fixed bed treatment columns.

The process time of one or more of the treatment steps can differ significantly from the process time required for the remainder of the treatment steps within a cycle or where a pressure limitation may exist for one or more treatment steps of the cycle. The productivity of the multi-step treatment system is increased by utilizing the parallel sets of columns within a block for rate-limiting treatment steps without compromising the recovery and quality of the product. In other words, a process time for one block of fixed-bed treatment columns is greater than a process time for another block of fixed-bed treatment columns and the fixed bed treatment columns of the block with the greater process time are configured in a parallel arrangement to perform the corresponding step of the multi-step treatment system to increase productivity of the multi-step treatment system. Parallelization mitigates the constraint inherent in the slower treatment steps of a chromatography, adsorption, or ion exchange cycle. In some examples, multiple blocks each include fixed-bed treatment columns fluidly connected in parallel within their respective block to further increase productivity of the multi-step treatment system.

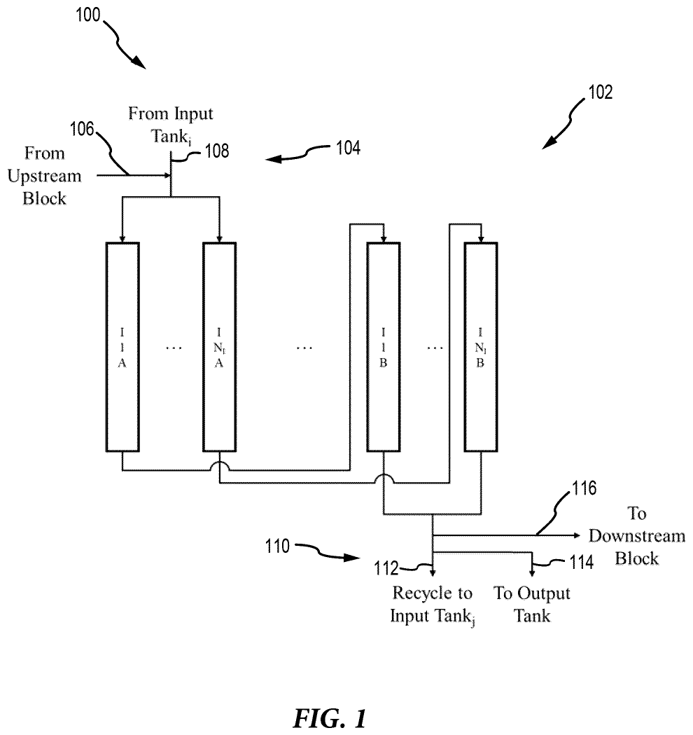

FIG. 1 is an illustration of potential input and output flow pathways of a single block 102 or treatment step for a multi-step treatment system 100 within an example chromatography system, adsorption system, or ion exchange system. The disclosed multi-step treatment system 100, and other continuous chromatography, adsorption, or ion exchange systems (e.g., systems 200, 300) disclosed herein can be visualized as a collection of blocks where each block performs a distinct function within an overall chromatography, adsorption, or ion exchange cycle. The block 102 can include one or more sets of columns (e.g. 1-N_{I}) operating in parallel to optimally complete the function of the block 102. In some examples, a single set of columns within the block 102 may contain one or more columns operating in series to complete the function of the block 102. The input streams 104 into the block may include effluent 106 from a prior block upstream in the system 100 and/or injected fluid from an input tank 108 upstream of the system 100. The output streams 110 from the block 102 may include a fraction of effluent recycled to an input tank 112, a fraction of effluent to an output tank 114, and/or a fraction of effluent forwarded to a downstream block 116.

Note that the directions of the flow arrows are not to be construed as to be in any particular relationship to the direction of gravity. The capital roman numerals identify blocks of columns, each block performing a distinct step of the chromatographic, adsorption, or ion exchange cycle in parallel. Although various examples have been illustrated using four blocks, a person of skill having the benefit of this disclosure would understand that some systems may include more than four blocks and some systems may include less than four blocks. For example, as shown in FIG. 1, each of the columns I1A through IN_{I}A and I1B through IN_{I}B perform a first treatment step of the multi-step treatment system 100 (e.g., an ion exchange system). The columns within FIGS. 1-9B are labeled using a capital roman number (e.g. I-IV) followed by a number (e.g. 1-N_{I}) followed by a capital letter (e.g. A-B). The indexing from 1 to N_{I} represents the number of sets of columns operating in parallel within a given block to complete a particular step of the chromatography, adsorption, or ion exchange cycle. The indexing from A to B (e.g. I1A, I1B) represents the number of columns of a group of columns in series within a particular set of columns with the lead column identified with the letter A and the lag column identified with the letter B.

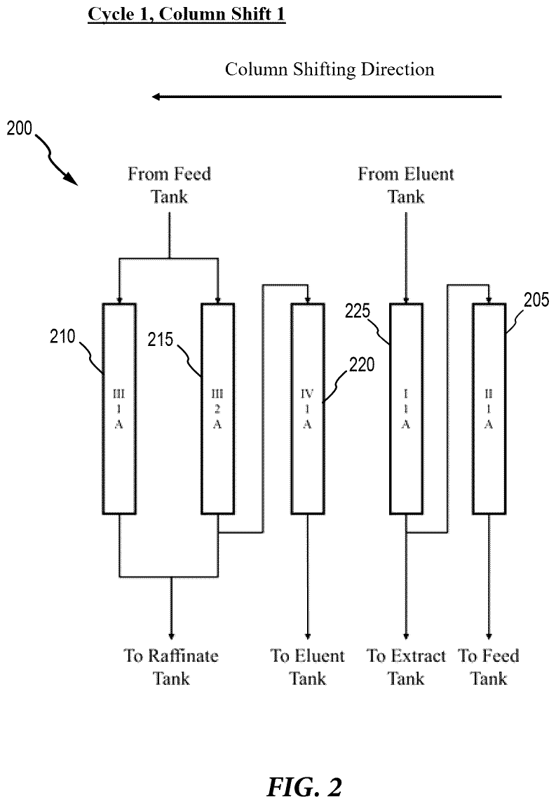

In some examples, the first group of fixed-bed treatment columns (A) can include a number of columns between 1 and 20, such as between 1 and 10. The two columns shown in each group (A) and (B) are linked to one another in series. In other words, a second group (B) of fixed-bed treatment columns is fluidly connected in series to the first group (A) of fixed-bed treatment columns within the block. Note that the multi-step treatment system 100 is not limited to the number of columns connected in series with a group of columns within a given block. In some examples, multiple blocks within the multi-step treatment system 100 can include parallel sets of columns. Further, the multi-step treatment system 100 can be a continuous process. As illustrated with respect to FIGS. 2-7, the blocks are defined by the function being performed and rotate through various columns through the sequential column shifts.

The multi-step treatment system 100 can include a continuous fixed bed separation system. The system 100 can include at least one of a chromatography system, adsorption system, or ion exchange system. The system 100 can include a fluid configured to flow through the system 100, from a first block of fixed-bed treatment columns I to perform a first treatment step to a second block of fixed-bed treatment columns II to perform a second treatment step of the multi-step treatment system. The system can include other blocks of fixed-bed treatment columns (e.g., III, IV, etc.) to perform other sequential treatment steps of the continuous fixed bed separation system. Each of the columns or set of columns within the system 100 are fluidly connected. However, the multi-step treatment system 100 can further include tanks and/or other processes configured to store and/or further treat the fluid as utilized for the chromatography system, adsorption system, or ion exchange system.

In some embodiments, fluid within a block may include additional valves connected to the outlet flow of the columns in order to selectively divert fractions of the process streams to different process vessels or process tanks. As shown in FIG. 1, the output streams 110 from the block 102 may direct a fraction of effluent recycled to an input tank 112 during a first outlet switch, direct a fraction of effluent to an output tank 114 during a second outlet switch, and direct a fraction of effluent forwarded to a downstream block 116 during a third outlet switch. Upon completion of a sequence of outlet switches, the inlets and outlets for the system 100 will move to the next column downstream via the controlled switching of discrete valves, resulting in an overall column shift.

For example, the fluid can include a complex mixture. A liquid chromatography system can separate molecules in a liquid mobile phase using a solid stationary phase. In column liquid chromatography, as the liquid “mobile phase” passes through the column, components in the mobile phase interact to varying degrees with the solid stationary phase, also known as the chromatography media or resin. Molecules of interest in the mobile phase are separated based on their differing physicochemical interactions with the stationary and mobile phases. These interactions can be based on various properties of the molecules such as affinity, particle charge, molecular size, etc.

The multi-step treatment system 100 can include a resin or adsorbent disposed in the first block of fixed-bed treatment columns and second block of fixed-bed treatment columns. For example, an ion exchange material can possess electrically charged active sites containing functional groups that are replaced by target species in the fluid during ion exchange. Resins can be made from a polystyrenic polymer backbone in some applications, and differ by their predetermined specific functional groups. An adsorbent resin can include designable polymer adsorbents.

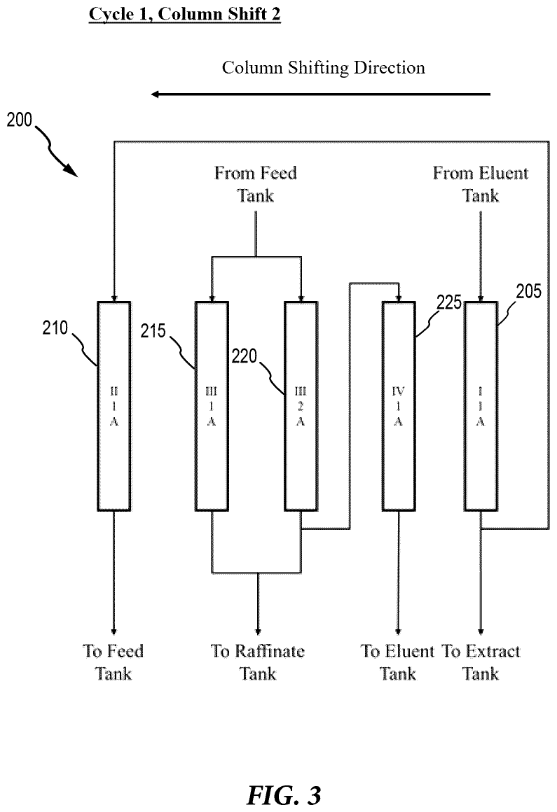

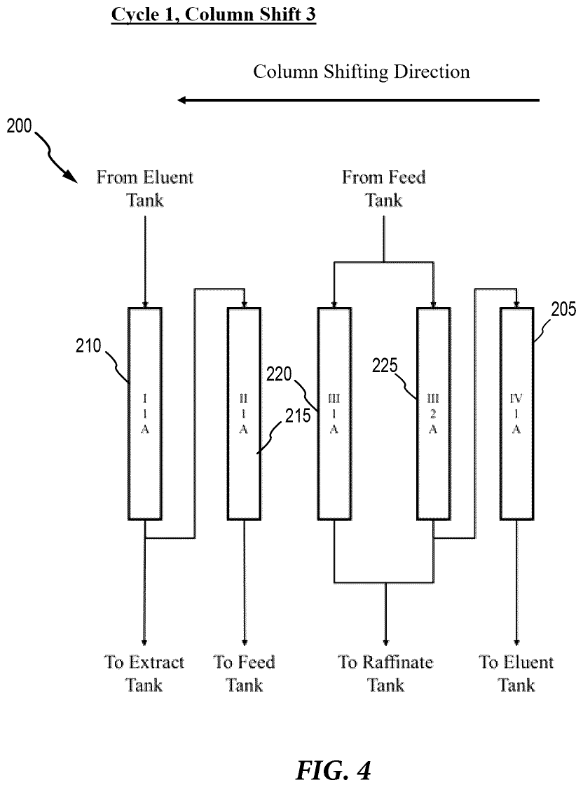

Referring now to FIGS. 2-7, the first treatment step of the multi-step treatment system 200 includes four blocks of an adsorption cycle: elution, feed displacement/rinse, loading, and eluent recycle. Block I desorbs components retained on the solid-phase media (elution); block II displaces residual feed material that does not strongly interact with the solid-phase media (rinse); block III binds components in the feed mixture to the solid-phase media (loading); and block IV produces a portion of purified eluent to recycle for subsequent elution steps (recycle). The positions of the blocks are not static and effectively shift one column downstream at the conclusion of each column shift interval. Once a treatment step is completed, a column shift is initiated. For example, FIG. 3 shows a column shift from FIG. 2 and FIG. 4 shows a column shift from FIG. 3. The effect of the column shifting results in that every column will at specific points of time fulfill the function of each step of the chromatography, adsorption, or ion exchange cycle. In other words, the valve system alternates valve positions to change inlets and outlets for the multi-step treatment system 200 such that each column of the multi-step treatment system 200 conducts each treatment step in a cycle of the multi-step treatment system 200. As discussed above with respect to FIG. 1, during a column shift interval, a subset of valves can be selectively opened and closed to divert fractions of the process streams to different process vessels or process tanks. The process time of the four blocks of the adsorption cycle can vary.

FIG. 2 shows a multi-step treatment system 200 that includes a first block of columns I, a second block of columns II, a third block of columns III, and a fourth block of columns IV in series. For purposes of illustrating FIGS. 2-7, the third block of columns III has a process time longer than the first block of columns I, second block of columns II, and fourth block of columns IV. The multi-step treatment system 200 includes a valve system (as represented by flow lines) configured to alternate position of the valves to direct fluid flow and conduct an adsorption cycle. In some examples, the valve system can alternate position at a predetermined frequency defined by a time or a processed fluid volume to modify a fluid flow within the designated blocks of columns I, II, III, and IV. The blocks of columns are generally operated in series, except two of the five sets of columns are operated in parallel within the series in order to provide additional time to complete the loading step (Block III).

The complete sequence of an adsorption cycle utilizing five columns with two columns operating in parallel within block III is depicted in FIGS. 2-7. Throughout FIGS. 2-7, the column's physical positions are fixed but the valve system is cycled through a plurality of valve positions, as illustrated by changes of the flow lines.

For example, FIG. 2 shows the first column shift interval of a five column adsorption sequence that includes four blocks of columns. Each block or set of columns is configured to perform a distinct function within the adsorption cycle, namely, I) elution, II) feed displacement, III) loading, and IV) eluent recycle. As shown, the loading step includes two fixed bed treatment columns III1A and III2A that are configured in a parallel arrangement.

The loading function is modified for achieving maximal resin or adsorbent productivity through the use of multiple sets of columns operating in parallel (i.e., III1A and III2A) within the block III to suitably balance the duration of each step of the chromatography, adsorption, or ion exchange cycle. As shown in FIG. 2, each set of columns (i.e., III1A and III2A) includes only one column but other examples may include multiple columns per set. Likewise, although block III is illustrated with two columns (III1A and III2A) in parallel, other examples may include more than two columns in parallel within a block, such as between 3 and 10 columns in parallel within a block.

As shown in FIG. 2, column 225 is positioned to conduct the elution step (block I), column 205 is positioned to conduct the feed displacement step (block II), columns 210 and 215 are positioned to conduct the loading step (block III), and column 220 is positioned to conduct the eluent recycling step (block IV). As shown, the loading step includes two fixed bed treatment columns 210, 215 that are configured in a parallel arrangement.

FIG. 3 depicts the second column shift interval of a five column adsorption sequence that includes four blocks of columns. The change in the positions of the valve system shifts the location of the cycle steps from the positions shown in FIG. 2. In other words, the column shifts change the cycle step of each column in the system 200 by providing a flow path through the multi-step treatment system 200. The valve system can be configured to alternate position at a predetermined frequency defined by a time or a processed fluid volume to modify flow within the blocks of fixed bed treatment columns. For example, column 205 is positioned to conduct the elution step (block I), column 210 is positioned to conduct the feed displacement step (block II), columns 215 and 220 are positioned to conduct the loading step (block III), and column 225 is positioned to conduct the eluent recycling step (block IV). As shown, the loading step includes two fixed bed treatment columns 215, 220 that are configured in a parallel arrangement.

Notably, column 215 was also positioned to conduct the loading step in the first column shift interval, shown in FIG. 2. As a result, column 215 is able to perform this step during the first column shift interval (shown in FIG. 2) and the second column shift interval (shown in FIG. 3) while the elution, displacement, and recycling steps are completed during a single column shift interval. As such, the loading function (block III) is modified for achieving maximal resin or adsorbent productivity through the use of multiple sets of columns operating in parallel (i.e., III1A and III2A) to suitably balance the duration of each step of the chromatography, adsorption, or ion exchange cycle. Depending on the stage of the adsorption cycle, the same column can be operating in parallel at one point and operating in series at another as required for the multi-step treatment system 200.

A further comparison of the column shift from FIG. 2 to FIG. 3 illustrates how the same column can be operating in parallel at one point and operating in series at another. FIG. 2 depicts the first column shift interval of the five column adsorption sequence with the valve system in the first valve position. FIG. 3 depicts the second column shift interval of the five column adsorption sequence with the valve system in the second valve position. When the valve system is in the first valve position, the valve system arranges the column 220 into block IV and arranges column 215 and column 210 parallel into block III. When the valve system is in the second valve position, the valve system arranges column 220 and column 215 parallel into block III and arranges column 210 into block II. Thus, column 210 is no longer in parallel.

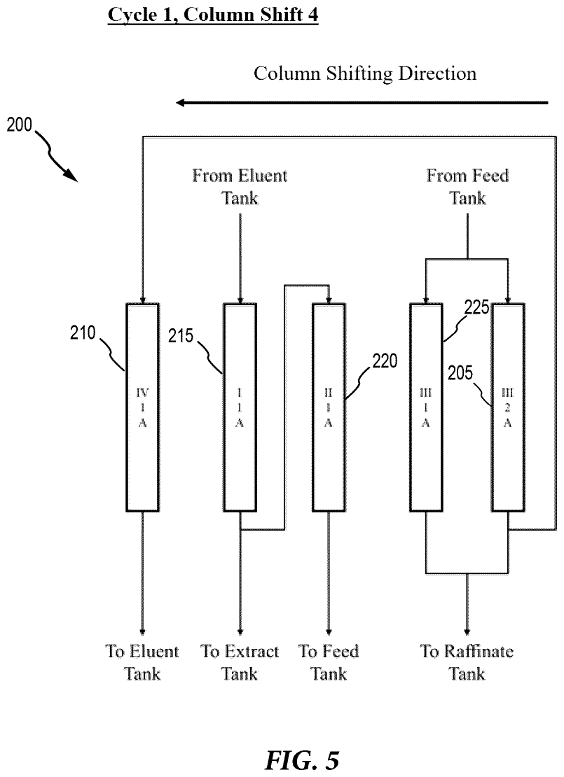

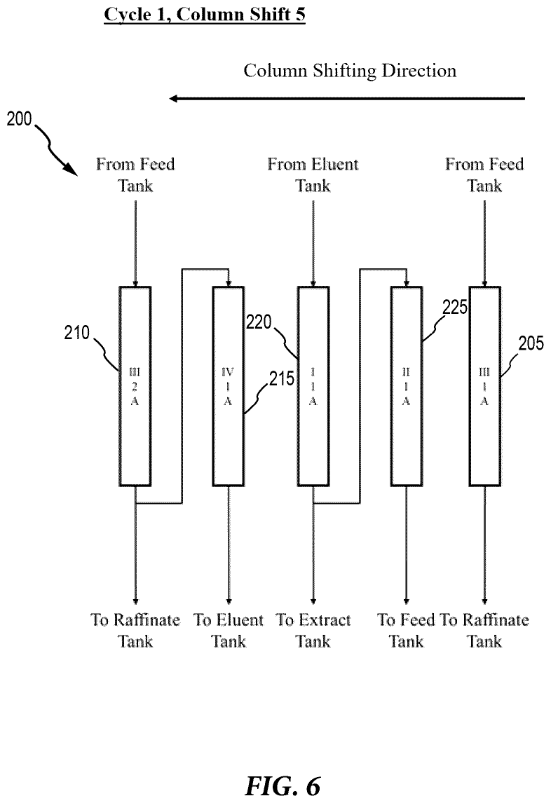

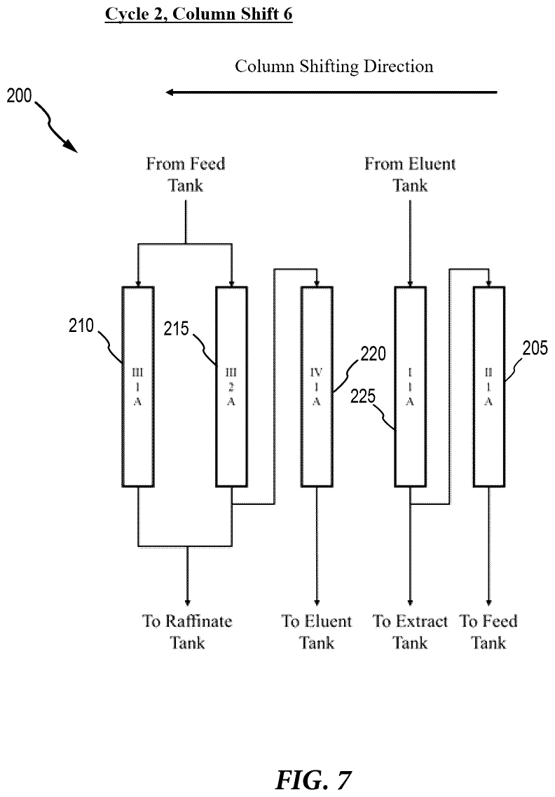

FIG. 4 depicts the third column shift interval of a five column adsorption sequence with the valve system in a third valve position. The change in the functions of the columns compared to FIG. 3 indicates a given column performing a different step in the adsorption sequence. FIG. 5 depicts the fourth column shift interval of a five column adsorption sequence with the valve system in a fourth valve position. The change in the functions of the columns compared to FIG. 4 indicates a different step in the adsorption sequence. FIG. 6 depicts the fifth column shift interval of a five column adsorption sequence with the valve system in a fifth valve position. The change in the functions of the columns compared to FIG. 5 indicates a different step in the adsorption sequence. FIG. 7 depicts the sixth column shift interval of a five column adsorption sequence with the valve system in a sixth valve position. The change in the functions of the columns compared to FIG. 6 indicates a different step in the adsorption sequence. At this point, the five column adsorption system has completed one full adsorption cycle and the valve configuration has returned to the same state as shown in FIG. 2. As may be appreciated from FIGS. 2-7, each of columns 205, 210, 215, 220, 225 performs each treatment step of the adsorption process. In addition, by selectively operating different pairs of columns in parallel during each column shift interval, the process time for the loading step (block III) is twice the time of the other steps.

Applications such as ion exchange may require more than four blocks due to additional resin conditioning steps, sequential elution of products, and/or cleaning-in-place procedures. For the case where any one or more of these blocks is rate-limited or pressure-limited, additional sets of columns may be added within the block to execute the function of the block over multiple steps while enabling other steps that are not rate-limited to be executed over a shorter period of time.

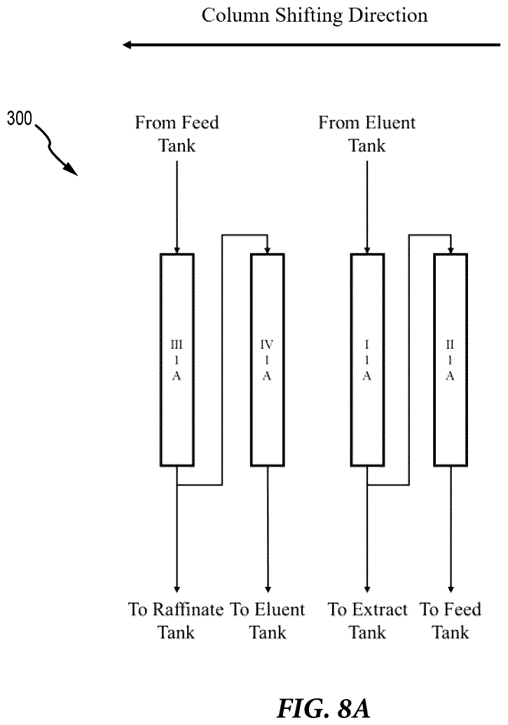

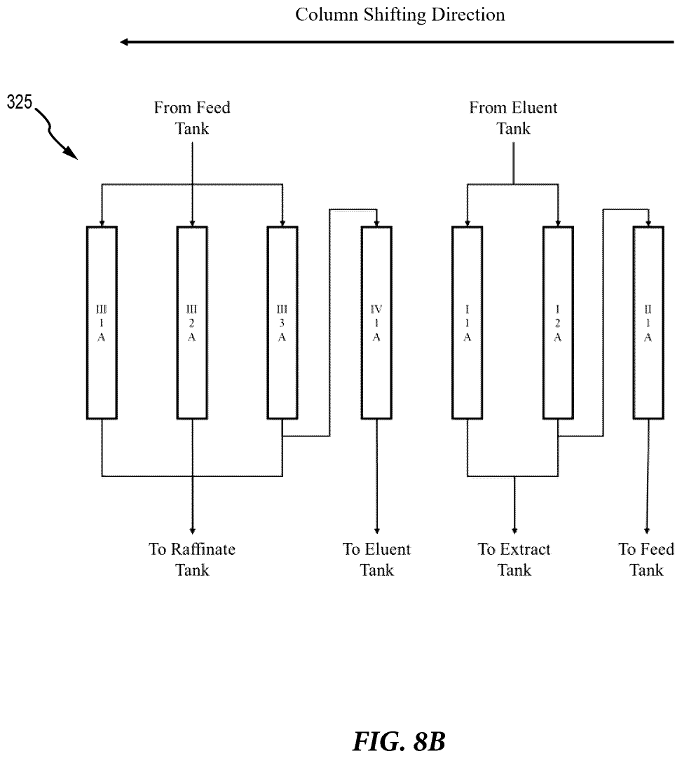

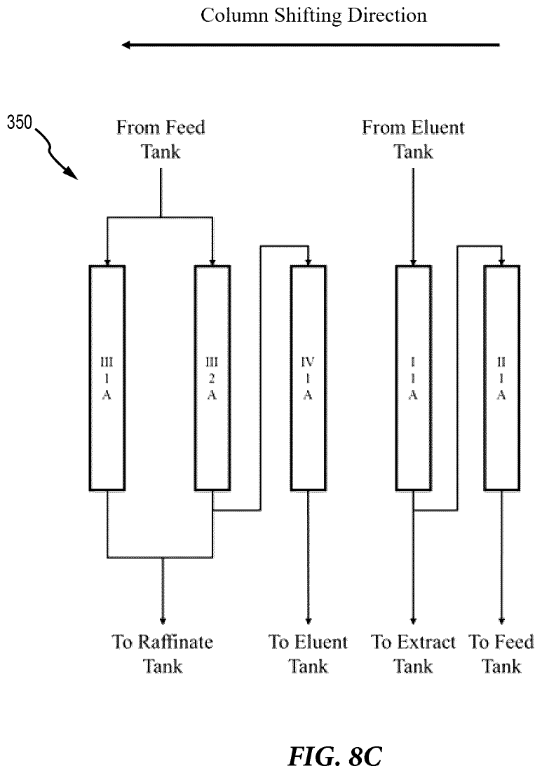

FIG. 8A illustrates a known constraint that is produced when a single treatment step of the chromatography, adsorption, or ion exchange cycle must be executed over a longer duration than the other treatment steps of the cycle. FIG. 8A illustrates a continuous chromatography system, adsorption system, or ion exchange system 300 that includes at least the steps of elution (block I), feed displacement (block II), loading (block III), and eluent recycle (block IV). In an example, the requirement of 30 minutes for loading in block III can cause the other treatment steps of the cycle to be executed over a long time period or for the columns in a block to complete the cycle step early and idle in standby mode until the next column shift. This standby and/or delay leads to a lower productivity of the chromatography system, adsorption system, or ion exchange system 300. As an example, the productivity of this system is 0.075 system volumes per hour. As a non-limiting example, FIG. 8A can illustrate a typical system 300 for purifying fructose from a high fructose corn syrup feedstock. In fructose purifying, the typical approach shown as system 300 would be constrained by the pressure drop across the loading column (i.e., block III) due to the high viscosity of the high fructose corn syrup material injected into the column. The flowrates in blocks I, II, and IV, could be increased without greatly affecting system performance if a slower flowrate was not required for the loading step in block III of the cycle.

FIG. 8B illustrates the benefits of operating multiple blocks of columns in parallel by enabling the short cycle steps to be operated in as short a period of time as possible. FIG. 8B illustrates a multi-step treatment system 325 with the steps of elution (columns I1A and I2A) and loading (columns III1A, III2A, and III3A) in parallel and feed displacement (column II1A) and eluent recycle (column IV 1A) steps operated in series, without any parallel columns. The addition of a second and a third column (III2A and III3A) in the loading step (i.e., block III) effectively enables three columns to be loaded in parallel at the same flowrate as the system 300 shown in FIG. 8A, with each column shift between configurations able to occur in a third of the time.

Similarly, the addition of a second column (I2A) in block I will effectively enable two columns to be optimally eluted in parallel at 1.5 times the flowrate as the system in FIG. 8A with each column shift occurring in a third of the time. For a single column shift interval, each of the two columns in block I would be eluted with half of the quantity of material as the system shown in FIG. 8A. As a result of this improvement, the step time may be lowered (such as from four hours to two hours), enabling the other cycle steps to be completed using less time.

Referring back to the loading block III of columns III1A, III2A, and III3A in parallel, for a single column shift interval, each of the three columns III1A, III2A, and III3A in block III can be loaded with one third of the quantity of material as the system shown in FIG. 8A. In other words, three columns operating in parallel in the loading block can be loaded with a third of the total feed volume to be loaded. As a result of this improvement, the step time may be lowered from six hours to two hours, enabling the other cycle steps to be completed using less time. The productivity of this example system may be 0.129 system volumes per hour, yielding a 71% increase in productivity compared to the system shown in FIG. 8A.

FIG. 8C illustrates an embodiment of a multi-step treatment system 350 that includes a continuous fixed bed separation system including at least one of a chromatography system, an adsorption system, or ion exchange system. The addition of a second column III2A in block III will effectively enable two columns III1A and III2A to be loaded in parallel at the same flowrate as the system in FIG. 8A with each column shift occurring in half the time. For a single column shift interval, each of the two columns III1A and III2A in block III would be loaded with half of the quantity of material as the system in FIG. 8A, however the column III1A would be loaded with the same quantity of material after two column shifts as the system in FIG. 8A. This adds a degree of operational freedom that enables the flowrates in the columns of blocks I, II, and IV to be doubled, thus yielding a 60% improvement in overall system productivity.

This results in an improved resin or adsorbent productivity by using a higher number of columns. However, counterintuitively, due to the higher productivity, the volume of resin or adsorbent required for the separation will be greatly reduced even though more vessels have been added to the system.

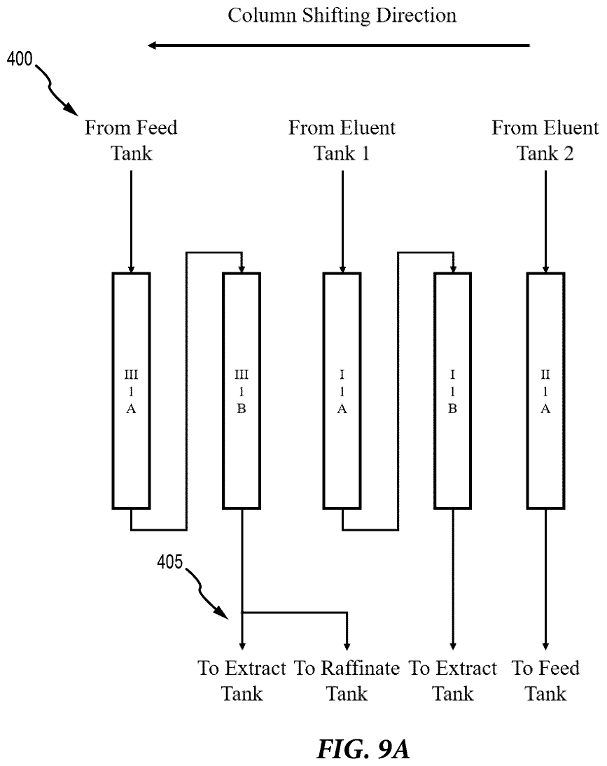

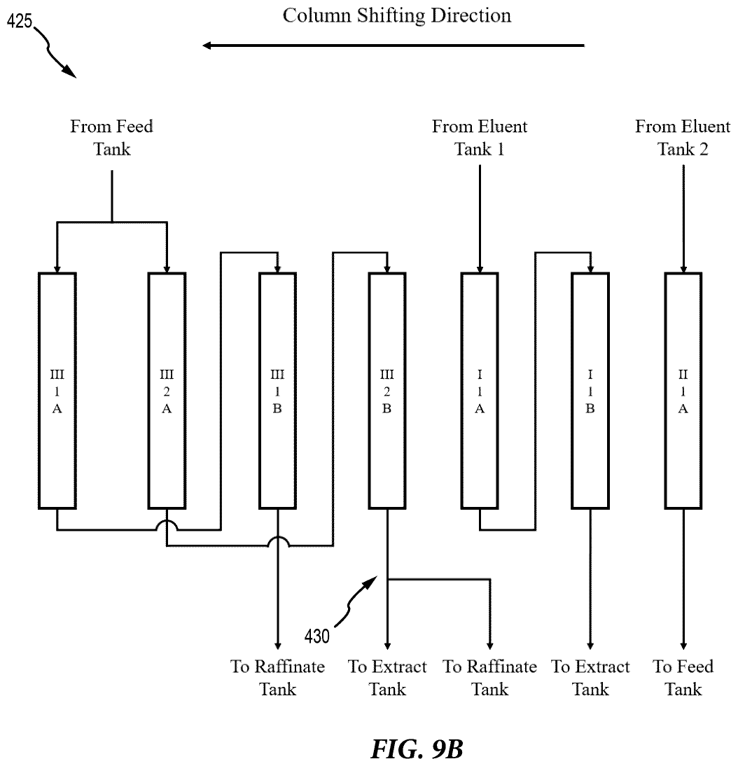

FIG. 9A illustrates an example continuous adsorption system 400 for direct lithium extraction where the rate of adsorption constrains the required duration of the loading step of the adsorption cycle. Notably, the stream 405 from the loading block III1A, III1B is split between the extract tank and the raffinate tank. FIG. 9B illustrates one column shift interval of a continuous adsorption system 425 for direct lithium extraction which improves the productivity of the continuous chromatographic system in FIG. 9A by operating the loading block III with two columns III1A and III2A in parallel. Also, as shown, block III includes a second group of columns in series (III1B and III2B) to the two columns III1A and III2A. At the beginning of the column shift interval, the output stream 430 from block III2B is directed into the extract tank. During operation over the column shift interval, the valve system executes an outlet switch to divert a fraction of effluent to the raffinate tank. At the conclusion of the column shift interval, the outlet switch is again executed with the column shift to again direct the output stream into the extract tank, but within the next column shift interval. In this embodiment, the productivity of the continuous adsorption system is increased by 43% through parallelizing the loading step across the two blocks of columns III1A and III2A and further dividing the block III treatment step into a subset performing different portions of the same cycle step (e.g., block III) simultaneously.

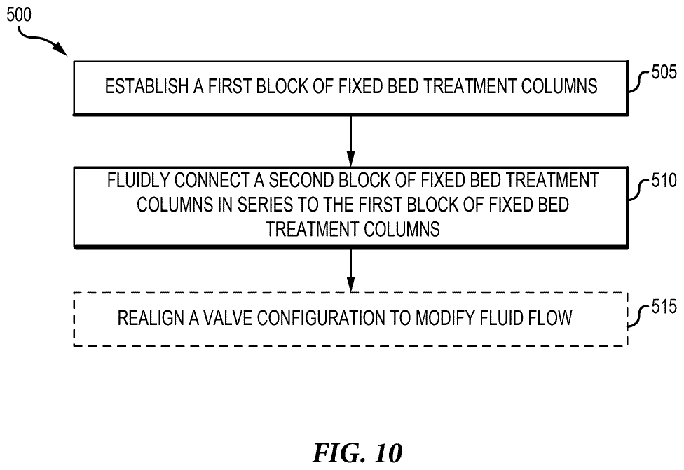

FIG. 10 illustrates a method 500 of increasing the productivity of a continuous fixed bed separation system through the use of parallel blocks of columns executing rate limited cycle steps. During each step, feed and one or more eluent streams can be injected into specific blocks or columns of the system while raffinate and extract products are withdrawn from the outlets of block specific columns. Additionally, a portion of the extract product may be recycled to the eluent tank to increase the achievable concentration of a retained component in the extract beyond what may be observed without extract recycle which lowers capital and operating costs on operations downstream of the system. The method 500 includes establishing a plurality of blocks of fixed bed treatment columns to perform a corresponding number of treatment steps in a multi-step separation treatment system, with each block configured to perform a respective treatment step of the multi-step separation treatment.

Specifically, method 500 can include an act 505 of establishing a first block of fixed-bed treatment columns configured to perform a first treatment step of a multi-step treatment system. The method 500 can further include an act 510 of fluidly connecting a second block of fixed-bed treatment columns in series to the first block of fixed-bed treatment columns. The second block of fixed-bed treatment columns can be configured to perform a second treatment step of the continuous fixed bed separation system. The method 500 can further include establishing a third block and/or a fourth block and fluidly connecting all of the blocks in series. In some examples, the continuous fixed bed separation system is a chromatography system, an adsorption system, or ion exchange system. In some examples, the first treatment step and the second treatment step of the system can include at least one of an elution, feed displacement, rinsing, loading, or eluent recycle. The second block of fixed bed treatment columns can be configured in a parallel arrangement. A process time for the second block of treatment columns is greater than a process time for the first block of treatment columns.

In some examples, the method 500 can also include an act 515 of realigning a valve configuration to modify a flow path within the blocks of fixed-bed treatment columns. Realigning the valve configurations changes inlets and outlets for the continuous fixed bed separation system such that each column of the plurality of fixed bed treatment columns conducts each treatment step in a cycle of the continuous fixed bed separation system. The valve configurations can be alternated at a predetermined frequency defined by a time or a processed fluid volume to modify a flow path within the designated sets of treatment columns. Through valve configurations and the resin or adsorbent disposed in the treatment columns, the same column can be operating in parallel at one valve configuration and operating in series at another valve configuration.

### Example

A brine source that is rich in lithium is processed using two adsorption system configurations. First, a multi-step treatment system including a five column system without an in-block parallelization of treatment steps. Second, an embodiment of multi-step treatment system that utilizes seven columns with in-block parallelization of the loading step (e.g., see block III as shown in FIG. 9B). The results of the testing are shown below in Tables 1 and 2 for the two systems.

TABLE 1
Five Column System without In-Block Parallelization

| | Cation Concentration | | | | Lithium | | Lithium | Productivity [kg |
|---|---|---|---|---|---|---|---|---|
| | [mg/L] | | | | TDS | Lithium | Concentration | LCE / m³ |
| Stream | Li | Mg | Ca | B | Purity | Recovery | Factor | Adsorbent / day] |
| Feed | 433 | 4107 | 1001 | 372 | 9.80% | 92.0% | 1.13 | 32.4 |
| Extract | 488 | 73 | 112 | 156 | | | | |
| Raffinate | 33 | 3840 | 959 | 224 | | | | |

Seven Column System with In-Block Parallelization

| | Cation Concentration | | | | Lithium | | Lithium | Productivity [kg |
|---|---|---|---|---|---|---|---|---|
| | [mg/L] | | | | TDS | Lithium | Concentration | LCE / m³ |
| Stream | Li | Mg | Ca | B | Purity | Recovery | Factor | Adsorbent / day] |
| Feed | 411 | 4018 | 1018 | 369 | 8.20% | 90.7% | 1.12 | 45.4 |
| Extract | 462 | 125 | 120 | 152 | | | | |
| Raffinate | 33 | 3450 | 893 | 211 | | | | |

TABLE 2

As shown by comparing tables 1 and 2, the productivity of the lithium processing adsorption system of Table 2 increases by 40% while maintaining comparable levels of recovery and purity of the lithium-rich extract stream as compared to the five column system of Table 1. Note that the example is not to be construed as being exhaustive or exclusive as to the scope of this disclosure.

While the present disclosure has been described with reference to various embodiments, including preferred embodiments, it will be understood that these embodiments are illustrative and that the scope of the disclosure is not limited to them. Many variations, modifications, additions, and improvements are possible. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A continuous fixed bed separation system, comprising:
a plurality of fixed bed treatment columns, each column of the plurality of fixed bed treatment columns including a resin or adsorbent;
a valve system providing a continuous flow path through the plurality of fixed bed treatment columns, the flow path including an inlet and an outlet, wherein the flow path passes through at least one subset of columns of the plurality of fixed bed treatment columns in parallel; and
a controller configured to cyclically change the valve system to modify the position of the inlet and the outlet within the flow path and to modify the flow path through the plurality of fixed bed treatment columns,
wherein when the flow path through the plurality of fixed bed treatment columns is modified, for each of the at least one subset of columns, the subset of columns is modified to include a new subset of columns of the plurality of fixed bed treatment columns in parallel, the new subset of columns partially overlapping with the previous subset of columns such that at least one column of the new subset of columns was not within the previous subset of columns, at least one column of the previous subset of columns is not within the new subset of columns, and at least one column of the new subset of columns was within the previous subset of columns.

2. The system of claim 1, wherein the at least one subset of columns in parallel is at least two subsets of columns in parallel.

3. The system of claim 1, wherein the plurality of fixed bed treatment columns is between 3 columns and 20 columns.

4. The system of claim 1, wherein the controller is configured to cyclically change the valve system at a predetermined frequency defined by a time or a processed fluid volume.

5. The system of claim 1, wherein the system comprises a chromatographic system, an adsorption system, or an ion exchange system.

6. A continuous fixed bed separation system, comprising:
a plurality of fixed bed treatment columns, each fixed bed treatment column including a resin or adsorbent; and
a plurality of blocks of fixed bed treatment columns configured to perform a corresponding number of treatment steps in a multi-step separation treatment of mixtures, each block configured to perform a respective treatment step of the multi-step separation treatment, each block including at least one fixed bed treatment column;
wherein the plurality of blocks are fluidly connected in series, the plurality of blocks including at least a first block configured to perform a first treatment step and a second block to perform a second treatment step, wherein a process time for the second treatment step is greater than a process time for the first treatment step, and wherein the second block includes a plurality of fixed bed treatment columns in parallel fluid communication within the block.

7. The system of claim 6, wherein the plurality of blocks includes a third block, and the third block includes a plurality of fixed bed treatment columns configured in a parallel arrangement to perform a third treatment step of the multi-step separation treatment.

8. The system of claim 6, wherein the plurality of blocks includes a third block configured to perform a third treatment step and a fourth block configured to perform a fourth treatment step of the multi-step separation treatment.

9. The system of claim 6, wherein the first treatment step of the multi-step separation treatment comprises one of an elution step, a feed displacement step, a regeneration step, a conditioning step, a rinsing step, or an effluent recycle step.

10. The system of claim 9, wherein the second treatment step of the multi-step separation treatment comprises a loading step.

11. The system of claim 6, further comprising a valve system providing a flow path through the plurality of blocks of fixed bed treatment columns, the valve system operable to arrange the plurality of fixed bed treatment columns into the plurality of blocks and to connect the blocks in series within a flow loop, and
wherein the valve system is operable to cycle through a plurality of valve positions, each of the plurality of valve positions having a different arrangement of the plurality of fixed bed treatment columns into the plurality of blocks, each block having the same number of fixed bed treatment columns in each of the plurality of valve positions.

12. The system of claim 11, wherein at least two of the plurality of blocks each includes a plurality of fixed bed treatment columns in parallel fluid communication within the block.

13. The system of claim 11, wherein the plurality of fixed bed treatment columns is between 3 columns and 20 columns.

14. The system of claim 11, further comprising a controller configured to cycle through the plurality of valve positions at a predetermined frequency defined by a time or a processed fluid volume.

15. The system of claim 11, wherein the system comprises a chromatographic system, an adsorption system, or an ion exchange system.

16. A method to increase the productivity of a continuous fixed bed separation system, the method comprising:
fluidly connecting a plurality of fixed bed treatment columns with a valve system, each fixed bed treatment column including a resin or adsorbent, the valve system having a plurality of valve positions, each valve position arranging the plurality of fixed bed treatment columns into a plurality of blocks and connecting the blocks in series within a flow loop, each block including at least one fixed bed treatment column, at least one of the plurality of blocks including at least two fixed bed treatment columns in parallel fluid communication within the block, each block having the same number of fixed bed treatment columns in each of the plurality of valve positions, each of the plurality of valve positions having a different arrangement of the plurality of fixed bed treatment columns into the plurality of blocks;
simultaneously performing a plurality of treatment steps within the plurality of blocks, each treatment step of the plurality of treatment steps performed within a corresponding block;
removing a plurality of effluents from the flow loop via a plurality of outlets positioned between two adjacent columns of the plurality of fixed bed treatment columns; and
iteratively realigning the plurality of fixed bed treatment columns by cycling the valve system through the plurality of valve positions, wherein each column of the plurality of fixed bed treatment columns conducts each treatment step in a cycle of the plurality of valve positions.

17. The method of claim 16, wherein the plurality of fixed bed treatment columns comprises at least one of a chromatography system, an adsorption system, or an ion exchange system.

18. The method of claim 16, wherein iteratively realigning the plurality of fixed bed treatment columns comprises iteratively realigning the plurality of fixed bed treatment columns at a predetermined frequency defined by a time or a processed fluid volume.

19. The method of claim 16, wherein the plurality of treatment steps include an elution step, a loading step, a feed displacement step, a regeneration step, a conditioning step, a rinsing step, or an effluent recycle step.

20. The method of claim 19, wherein the plurality of treatment steps includes the loading step, the loading step is performed within a block of the plurality of blocks having at least two fixed bed treatment columns in parallel fluid communication.
